(19) United States
(12) Patent Application Publication
(10) Pub. No.: US 2010/0050829 A1
(43) Pub. Date: Mar. 4, 2010

(54) CHANGEABLE TOOL ASSEMBLY

(76) Inventor: Kun-Chen Chen, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/202,811

(22) Filed: Sep. 2, 2008

(51) Int. Cl. B25G 1/00; B25B 13/06; B25B 13/46

(52) U.S. Cl. 81/489; 81/121.1; 81/60

(57) ABSTRACT

A tool assembly has a grip, a core, a holding device and a tool head. The core is metal and solid, is mounted in the grip and has a first end and a second end protruding respectively from two ends of the grip. The holding device is mounted on the first end of the core and has a non-circular recess, a holding ball, a holding sleeve and a spring. The holding sleeve is slidably mounted around the first end of the core to push the holding ball partially protruding into and allow the holding ball to retract from the recess. The tool head is detachably mounted on the first end of the core by the holding device. The connecting tube has a non-circular cross section corresponding to the non-circular recess and an engaging recess detachably engaging the holding ball.

### BACKGROUND OF THE INVENTION

1. Field of the Invention

The present invention relates to a tool assembly, and more particularly to a tool assembly with a changeable tool head.

2. Description of Related Art

With reference to FIG. 12, a conventional wrench (60) comprises a handle (62) and at least one wrench head (64,642), wherein two heads (64,642) are shown. The wrench heads (64,642) are respectively formed integrally on two ends of the handle (62). With the wrench heads (64,642), a user can fasten or release a fastener, such as a bolt, nut or the like.

However, the wrench heads (64,642) of the conventional wrench (60) have fixed sizes, so the conventional wrench (60) can only be applied to a fastener with a specific size. Therefore, the conventional wrench (60) is not versatile in use. In addition, a user has to prepare multiple wrenches (60) with wrench heads (64,642) in different types or sizes for different needs, to carry multiple wrenches (60) is inconvenient and laborious.

To overcome the shortcomings, the present invention tends to provide a tool assembly to mitigate or obviate the aforementioned problems.

### SUMMARY OF THE INVENTION

The main objective of the invention is to provide a tool assembly with a changeable tool head to make the tool assembly convenient and versatile in use. The tool assembly comprises a grip, a core, a holding device and a tool head. The core is metal and solid, is mounted in the grip and has a first end and a second end protruding respectively from two ends of the grip. The holding device is mounted on the first end of the core and comprises a recess, a holding ball, a holding sleeve and a spring. The recess is non-circular and is defined in the first end of the core. The holding ball is retractably mounted in the first end of the core and protrudes into the recess. The holding sleeve is slidably mounted around the first end of the core to push the holding ball partially protruding into and allow the holding ball to retract from the recess. The spring is held in the holding sleeve and is mounted around the first end of the core to provide a force to the holding sleeve. The tool head is detachably mounted on the first end of the core by the holding device and has a connecting stub. The connecting tube has a non-circular cross section corresponding to the non-circular recess and an engaging recess defined around the connecting stub and detachably engaging the holding ball.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a tool assembly in accordance with the present invention;

FIG. 2 is an exploded perspective view of the tool assembly in FIG. 1;

FIG. 3 is a side view in partial section of the tool assembly in FIG. 1;

FIG. 4 is an exploded perspective view of a second embodiment of a tool assembly in accordance with the present invention with a different wrench head;

FIG. 5 is an exploded perspective view of a third embodiment of a tool assembly in accordance with the present invention with an adjustable wrench head;

FIG. 6 is a perspective view of the tool assembly in FIG. 5;

FIG. 7 is a side view in partial section of the tool assembly in FIG. 5;

FIG. 8 is an exploded perspective view of a fourth embodiment of a tool assembly in accordance with the present invention with a ratchet wrench head;

FIG. 9 is a perspective view of the tool assembly in FIG. 8;

FIG. 10 is a side view in partial section of the tool assembly in FIG. 8;

FIG. 11 is a side view of a tool case holding a tool assembly with multiple different wrench heads in accordance with the present invention; and

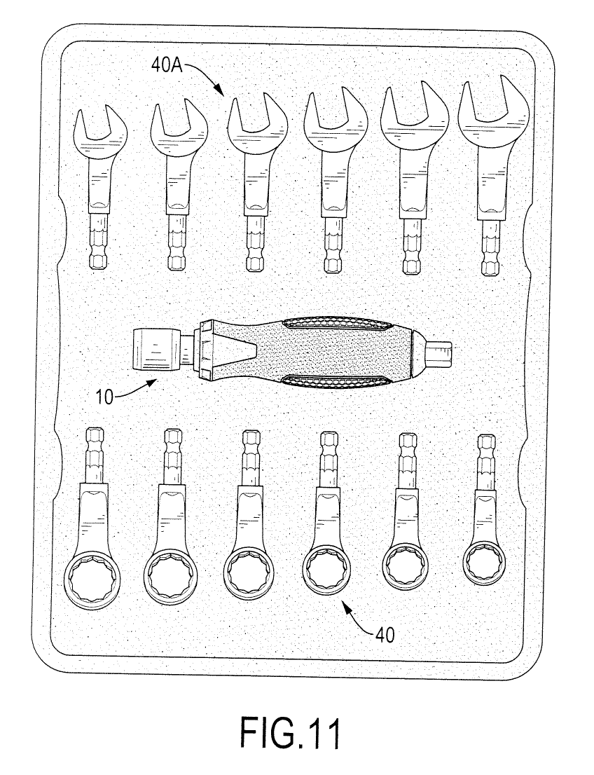

FIG. 12 is a perspective view of a conventional wrench in accordance with the prior art.

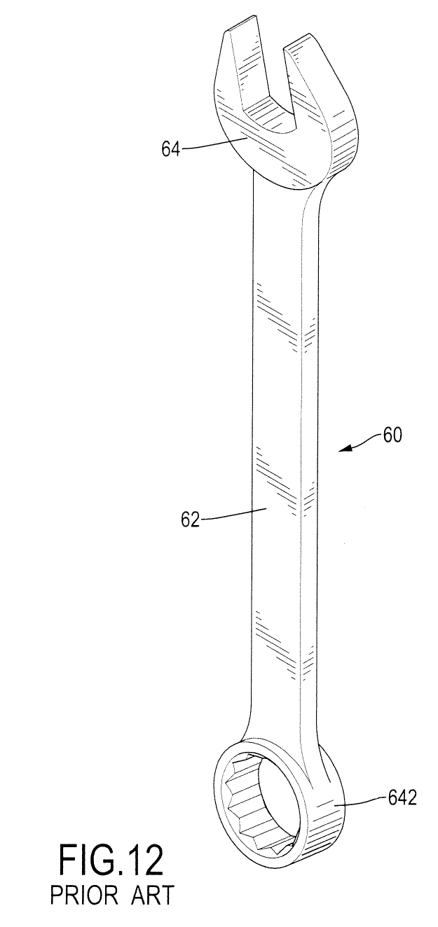

### DETAILED DESCRIPTION OF PREFERRED EMBODIMENT

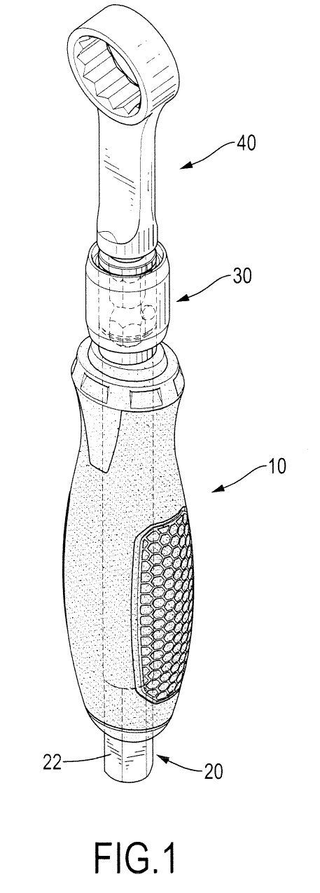

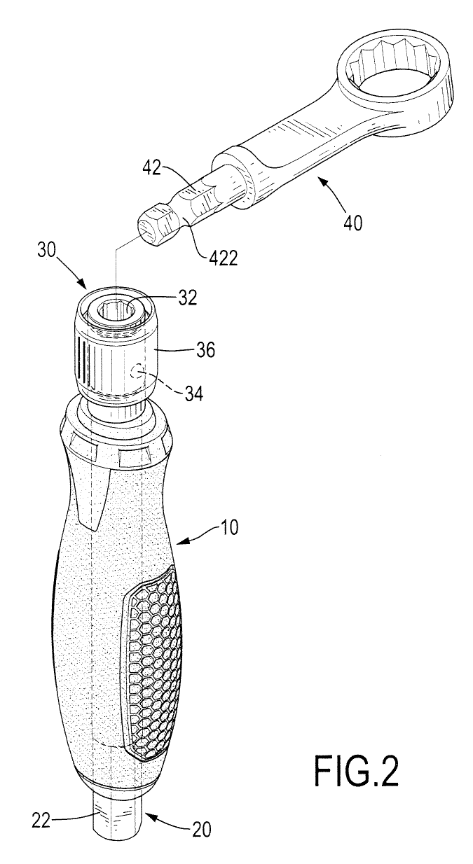

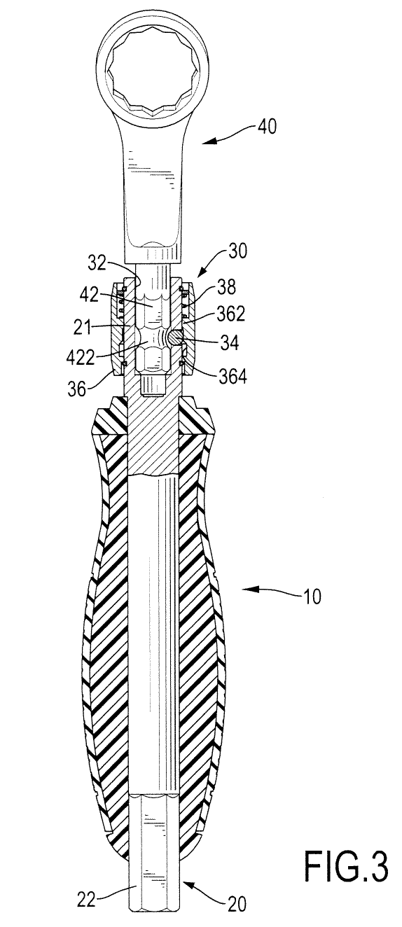

With reference to FIGS. 1 to 3, a tool assembly in accordance with the present invention comprises a grip (10), a core (20), a holding device (30) and a tool head. The grip (10) has two opposite ends and can be made of plastic material. The core (20) is metal and solid, is mounted in the grip (10) and has a first end (21) and a second end (22). The ends (21,22) of the core (20) protrude respectively from the ends of the grip (10). Preferably, the second end (22) of the core (20) has a hexagonal cross section.

The holding device (30) is mounted on the first end (21) of the core (20) and comprises a recess (32), a holding ball (34), a holding sleeve (36) and a spring (38). The recess (32) is non-circular, preferably hexagonal and is defined in the first end (21) of the core (20).

The holding ball (34) is retractably mounted in the first end (21) of the core (20) and protrudes into the recess (32).

The holding sleeve (36) is slidably mounted around the first end (21) of the core (20) to push the holding ball (34) partially protruding into and allow the holding ball (34) to retract from the recess (32). The holding sleeve (36) has an inner surface and an annular abutting flange (362) formed on the inner surface. An annular groove (364) is defined in the inner surface of the holding sleeve (36) below the abutting flange (362). When the holding sleeve (36) is slid to make the annular groove (364) aligning with the holding ball (34), the holding sleeve (36) can provide a space to holding ball (34) to retract from the recess (32).

The spring (38) is held in the holding sleeve (36) and is mounted around the first end (21) of the core (20). The spring (38) provides a force to the holding sleeve (36) to make the abutting flange (362) abutting against the holding ball (34) and to push the holding ball (34) to protrude into the recess (32).

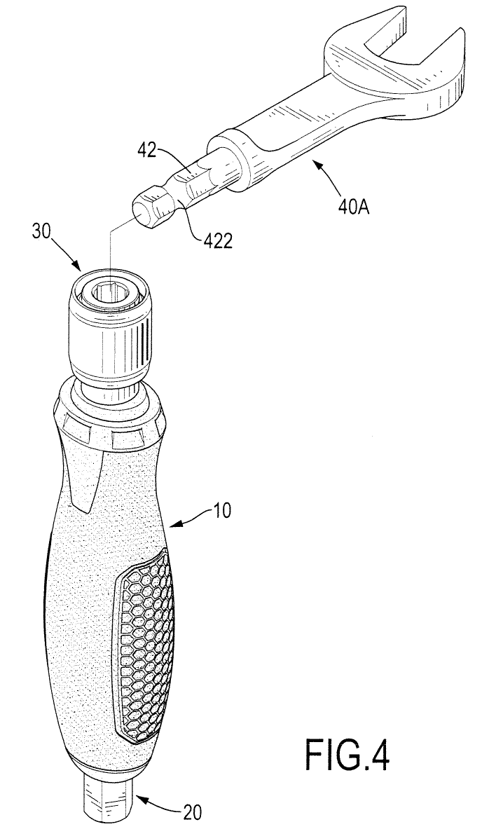

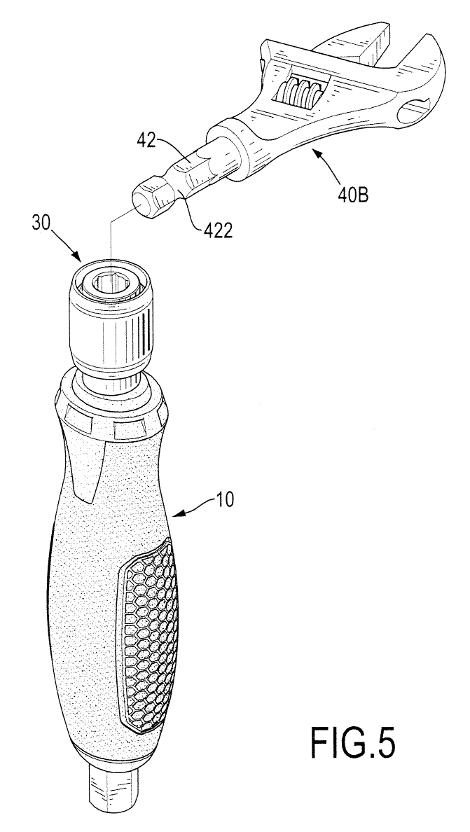

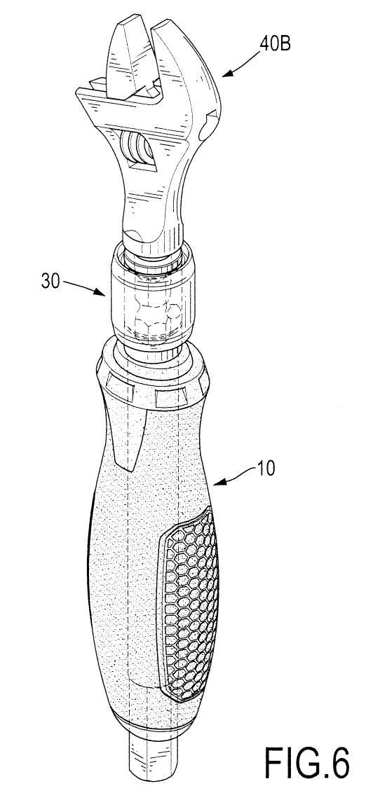

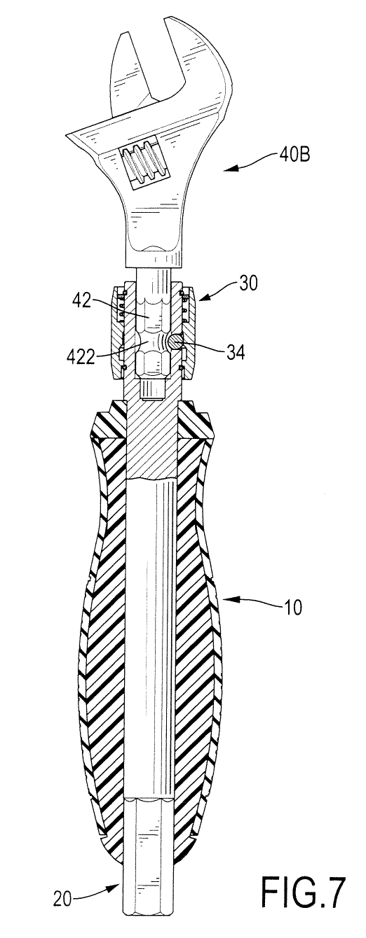

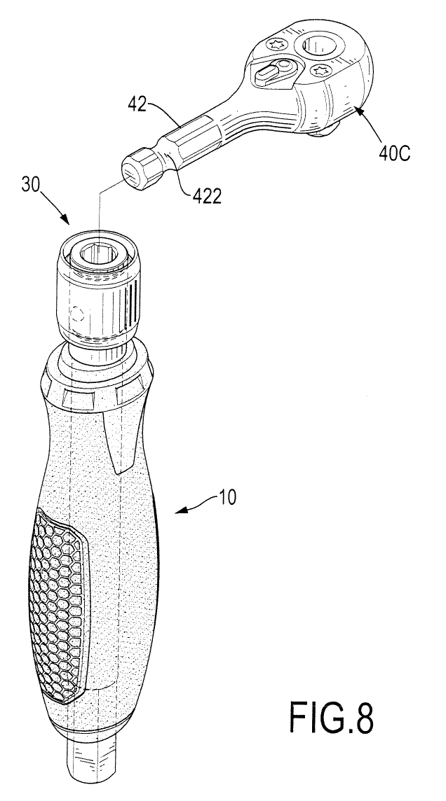

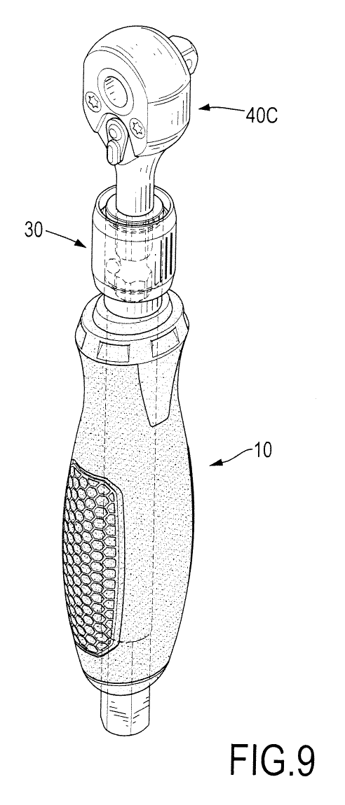

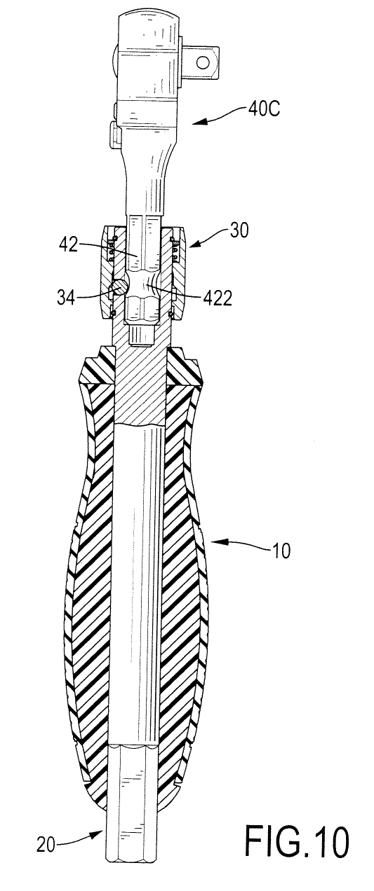

The tool head is detachably mounted on the first end (21) of the core (20) by the holding device (30) and may be a wrench head such as a socket wrench head (40) as shown in FIG. 1, an opened end wrench head (40A) as shown in FIG. 4. In another alternative embodiment, the tool head can be an adjustable wrench head (40B) as shown in FIGS. 5 to 7 or a ratchet wrench head (40C) as shown in FIGS. 8 to 10. Accordingly, the tool assembly can fit with different kinds of fasteners or tools, such as screws, bolts, nuts or sleeves with different tool heads (40,40A,40B,40C) and is versatile in use.

The tool head has a connecting stub (42) that has a non-circular cross section corresponding to the non-circular recess (32). Preferably, the connecting stub (42) has a hexagonal cross section. An annular engaging recess (422) is defined around the connecting stub (42) and detachably engages the holding ball (34). With the engagement between the engaging recess (422) and the holding ball (34), the wrench head (40,40A,40B,40C) is securely connected to the first end (21) of the core (20).

With such an arrangement, the tool assembly can be applied to fasten or release a fastener with the wrench head (40,40A,40B,40C). With the solid core (20), the tool assembly has an enough structural strength to bear the torque applied to the fastener, so the tool assembly is durable.

When the holding sleeve (36) is slid to a position where the annular groove (364) aligns with the holding ball (34), the holding ball (34) can retract from the recess (32) and disengages from the engaging recess (422) in the connecting stub (42). Consequently, the tool head can be detached from the first end (21) of the core (20).

Because the tool head is detachably mounted on the core (20) with the holding device (30), another tool head with different type or size can be attached to the core (20) after a previous one being detached from the core (20). Accordingly, the tool assembly can fit with different work conditions with multiple tool heads in different types or sizes and is convenient and versatile in use.

With reference to FIG. 1, in practice, multiple wrench heads (40,40A) and a single grip (10) can be held in a tool case, such that a user can easily carry the tool assembly with multiple wrench heads (40,40A) in different types and sizes to any desired working location. Accordingly, the tool assembly in accordance with the present invention is convenient and laborsaving in use and carrying.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tool assembly comprising:
a grip having two opposite ends;
a metal solid core mounted in the grip and having a first end and a second end protruding respectively from the ends of the grip;
a holding device mounted on the first end of the core and comprising
a non-circular recess defined in the first end of the core;
a holding ball retractably mounted in the first end of the core and protruding into the recess;
a holding sleeve slidably mounted around the first end of the core to push the holding ball partially protruding into and allow the holding ball to retract from the recess; and
a spring held in the holding sleeve and mounted around the first end of the core to provide a force to the holding sleeve; and
a tool head detachably mounted on the first end of the core by the holding device and having a connecting stub comprising
a non-circular cross section corresponding to the non-circular recess; and
an engaging recess defined around the connecting stub and detachably engaging the holding ball.

2. The tool assembly as claimed in claim 1, wherein the recess is hexagonal, and the connecting stub on the wrench head has a hexagonal cross section.

3. The tool assembly as claimed in claim 2, wherein the second end of the core has a hexagonal cross section.

4. The tool assembly as claimed in claim 3, wherein the wrench head is an opened end wrench head.

5. The tool assembly as claimed in claim 3, wherein the wrench head is a socket wrench head.

6. The tool assembly as claimed in claim 3, wherein the wrench head is an adjustable wrench head.

7. The tool assembly as claimed in claim 3, wherein the wrench head is a ratchet wrench head.

8. The tool assembly as claimed in claim 1, wherein the second end of the core has a hexagonal cross section.

9. The tool assembly as claimed in claim 1, wherein the wrench head is an opened end wrench head.

10. The tool assembly as claimed in claim 1, wherein the wrench head is a socket wrench head.

11. The tool assembly as claimed in claim 1, wherein the wrench head is an adjustable wrench head.

12. The tool assembly as claimed in claim 1, wherein the wrench head is a ratchet wrench head.
